(19) United States
(12) Patent Application Publication
(10) Pub. No.: US 2003/0154829 A1
(43) Pub. Date: Aug. 21, 2003

(54) Hand tool with a composite handle

(76) Inventor: Li-Tu Lin Wu, Taichung (TW)

Correspondence Address: Jackson Walker L.L.P., Suite 2100, 112 E. Pecan Street, San Antonio, TX, 78205, US

(21) Appl. No.: 09/756,393

(22) Filed: Jan. 8, 2001

(51) Int. Cl. B25B 23/16

(52) U.S. Cl. 81/177.1

(57) ABSTRACT

A hand tool with a composite handle includes a first body made of a steel alloy having a skeletal extension protruding from one end, and a second body coated on the outer periphery of the skeletal extension. The second body is made of composite material such as carbon fiber, fiberglass or the like. The composite material lighter than the steel alloy so that the hand tool is convenient to use. The composite material is a good insulator that can effectively prevent the user from getting an electric shock.

### BACKGROUND OF THE INVENTION

1. Field of the Invention

The present invention relates to a hand tool, and more particularly to a hand tool with a composite handle.

2. Description of Related Art

With reference to FIG. 4, a conventional hand tool in accordance with the prior art is made of steel alloy that is heavy. The heavy hand tool is inconvenient for a user to rotate to adjust a workpiece. In addition, the conventional tool is electrically conductive such that the user is susceptible to shock when the workpiece contacts an electrical source, thereby injuring the user or damaging the workpiece. Further, the conventional tool has virtually no elasticity and easily transmits vibrations when the user rotates the tool to adjust a workpiece, thereby decreasing the stability of the tool.

The present invention has arisen to mitigate and/or obviate the disadvantages of the conventional hand tool.

### SUMMARY OF THE INVENTION

In accordance with one aspect of the present invention, a hand tool with a composite handle comprises a first body made of steel alloy having a skeletal extension protruding from one end, and a second body coated on the skeletal extension of the first body. The second body is made of composite material such as carbon fiber, fiberglass or the like. The composite material is lighter than the steel alloy so that the hand tool is more convenient to use. The composite material is a good insulator that can effectively protect the user from an electric shock transmitted through the hand tool.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hand tool with a composite handle in accordance with the present invention, wherein the phantom lines show the skeletal extension used to connect the first body and the second body;

FIG. 2 is a side plan view of the hand tool with a composite handle in FIG. 1;

FIG. 3 is a side plan view of a hand tool with a composite handle in accordance with another embodiment of the present invention; and

FIG. 4 is a perspective view of a conventional hand tool in accordance with the prior art.

### DETAILED DESCRIPTION OF THE INVENTION

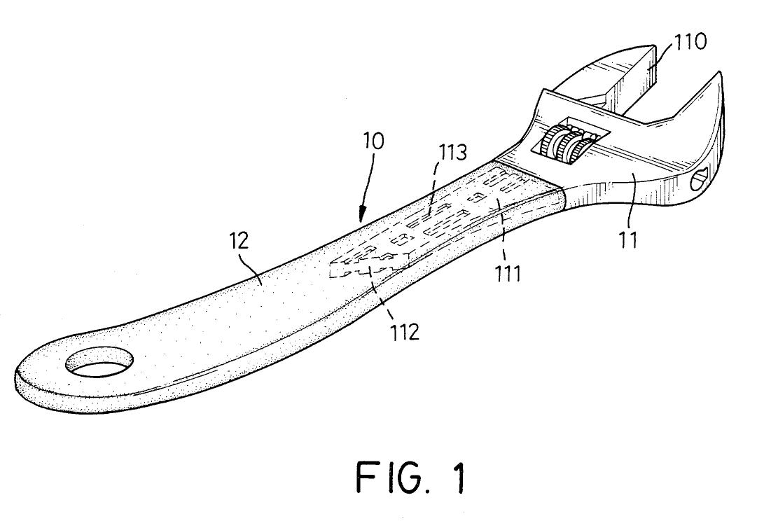

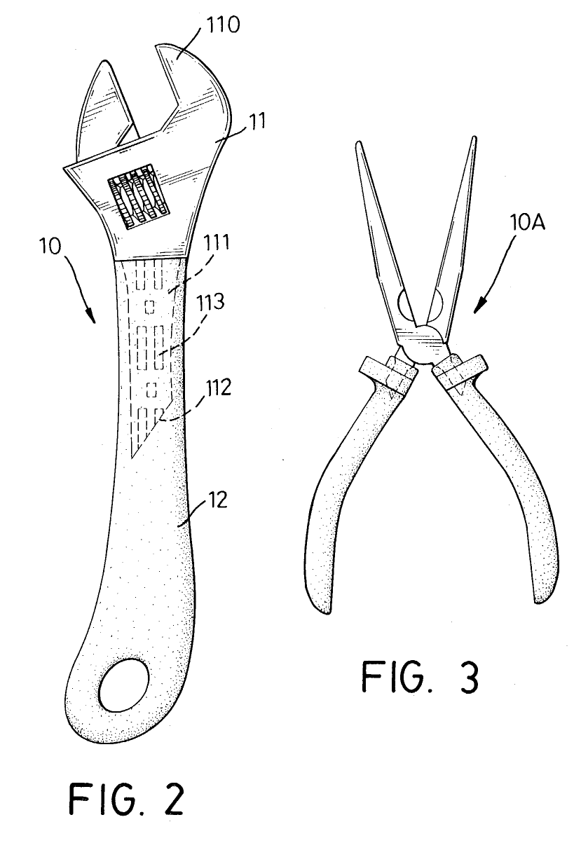

With reference to the drawings and initially to FIGS. 1 and 2, a hand tool with a composite handle in accordance with the present invention configured as an adjustable wrench (10) comprises a first body (11) and a second body (12). The first body (11) is made of a steel alloy and the second body (12) is made of carbon fiber or fiberglass. The second body is formed on the outer periphery of a skeletal extension of the first body (11).

The first body (10) includes a first end with two jaws (110) in opposition to each other to adjust a workpiece (not shown) and a second end having a skeletal extension (111) extending out from the first body (10). The skeletal extension (111) is coated by and secured in the second body (12). An acute portion (112) is formed on a free end of the skeletal extension (111) accordingly to the direction of the force when tightening a workpiece such as a bolt, and a series of fixing members (113) formed on an outer periphery of the skeletal extension (111). The acute portion (112) and the fixing members (113) are provided to improve the stability between the first body (11) and the second body (12). The fixing members (113), as shown in FIG. 1, are a series of recesses. However, the fixing members (11) may be different configuration such as ribs or through holes.

In such a manner, the second body (12) being made of carbon fiber that is light greatly decreases the weight of the composite tool handle, thereby decreasing the cost of fabrication, and thereby facilitating a user operating the composite tool handle. In addition, the second body (12) made of carbon fiber with great strength and rigidity can efficiently increase the vibration absorbing effect of the tool handle when the user rotates the handle to adjust a workpiece, thereby increasing the stability of the handle. Further, the composite handle with the second body (12) has a very corrosion and acid resistant.

Alternatively, the second body (12) being made of fiberglass can be used to increase the aesthetic quality of the tool handle or as a means of identification.

Further, the second body (12) made of carbon fiber or fiber glass can prevent a user from being shocked by an electric current due its insulating property, thereby assuring the user's safety when holding the handle of the present invention.

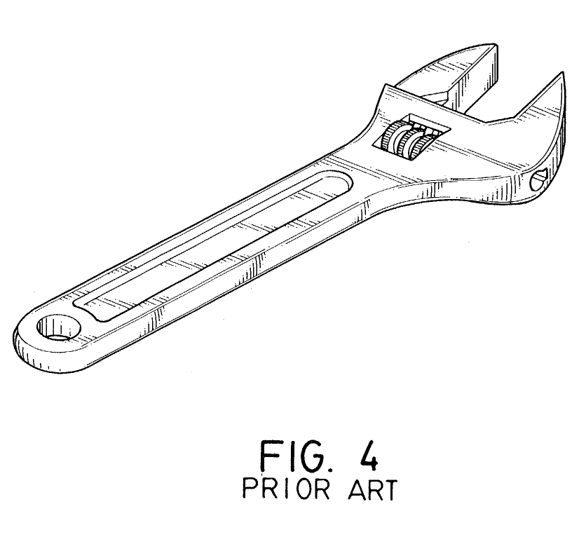

With reference to FIG. 3, in accordance with another embodiment of the present invention, the composite tool handle is configured as the handles for a pair of pliers.

Although the invention has been explained in relation to its preferred embodiment, it is to be understood that many other possible modifications and variations can be made without departing from the spirit and scope of the invention as hereinafter claimed.

What is claimed is:

1. A hand tool with a composite handle comprising:
a first body including a working piece formed on a first end of the first body and a skeletal extension formed and extending out from a second end of the first body, the skeletal extension having a outer periphery and a free end formed to be acute;
fixing members formed on the outer periphery of the skeletal extension; and
a second body coated on the outer periphery of the skeletal extension and used as a handle.

2. The hand tool with a composite handle as claimed in claim 1, wherein the first body is made of a steel alloy.

3. The hand tool with a composite handle as claimed in claim 1, wherein the second body is made of carbon fiber.

4. The hand tool with a composite handle as claimed in claim 1, wherein the second body is made of fiberglass.

5. The hand tool with a composite handle as claimed in claim 1, wherein the fixing members are recesses.

6. The hand tool a composite handle as claimed in claim 1, wherein the fixing members are through holes.

7. The hand tool with a composite handle as claimed in claim 1, wherein the fixing members are ribs.
